(19) United States
(12) Patent Application Publication
(10) Pub. No.: US 2002/0186181 A1
(43) Pub. Date: Dec. 12, 2002

(54) Projector computer

(76) Inventor: Richard Zodnik, San Juan Capistrano, CA (US)

Correspondence Address: IRELL & MANELLA LLP, 840 NEWPORT CENTER DRIVE, SUITE 400, NEWPORT BEACH, CA, 92660, US

(21) Appl. No.: 10/165,363

(22) Filed: Jun. 6, 2002

Related U.S. Application Data
(60) Provisional application No. 60/296,689, filed on Jun. 6, 2001.

(51) Int. Cl. G09G 3/00; G09G 5/00

(52) U.S. Cl. 345/32

(57) ABSTRACT

A projector computer that contains a computer and a light projector integrated into a single housing. The projector computer includes a processor, memory and a light projector that are all attached to the housing. The light projector is coupled to the processor so that the projector projects light generated by the computer. The projector computer does not require a monitor. The light projector can project the images generated by the computer onto any surface.

### REFERENCE TO CROSS-RELATED APPLICATION

This application claims priority to provisional Application No. 60/296,689 filed on Jun. 6, 2001.

### BACKGROUND OF THE INVENTION

1. Field of the Invention

The subject matter disclosed generally relates to a computer that has a light projector.

2. Background Information

Personal computers are typically packaged into two types “towers” and “laptops”. Towers are typically boxes that contain a processor, memory and other electrical circuits required for storing and processing. The tower is connected by cables to an external monitor, keyboard and mouse. Tower computers are advantageous because the processor can be upgraded without having to replace the monitor.

Laptop computers have the electronics, monitor and keyboard all integrated into one housing. Laptop computers are relatively small, lightweight and portable. Unfortunately, laptop computers typically utilize flat panel monitors which are susceptible to cracking.

There have been developed light projectors that can be coupled to computers to project a computer generated image onto a screen or other surface. For example, users may project POWERPOINT® presentations created and stored in the computer onto a screen or wall. Such projectors are not always accessible to the user thereby limiting the ability to conduct POWERPOINT® presentations. Additionally, utilizing computer controlled projectors requires interconnecting cables and a general knowledge of computers to connect the light projector to the computer.

### BRIEF SUMMARY OF THE INVENTION

A projector computer that includes a housing, a processor and memory attached to said housing and coupled to each other. The project computer also includes a light projector that is attached to the housing and coupled to the processor.

### BRIEF DESCRIPTION OF THE DRAWINGS

FIG. 1 is an illustration of a projector computer;

FIG. 2 is an illustration showing inner components of the projector computer;

FIG. 3 is an illustration showing the projector computer and a wireless keyboard that can be stored in a portable bag;

FIG. 4 is a schematic of an electrical system of the projector computer.

### DETAILED DESCRIPTION

Disclosed is a projector computer that contains a computer and a light projector integrated into a single housing. The projector computer includes a processor, memory and a light projector that are all attached to the housing. The light projector is coupled to the processor so that the projector projects light generated by the computer. The projector computer does not require a monitor. The light projector can project the images generated by the computer onto any surface.

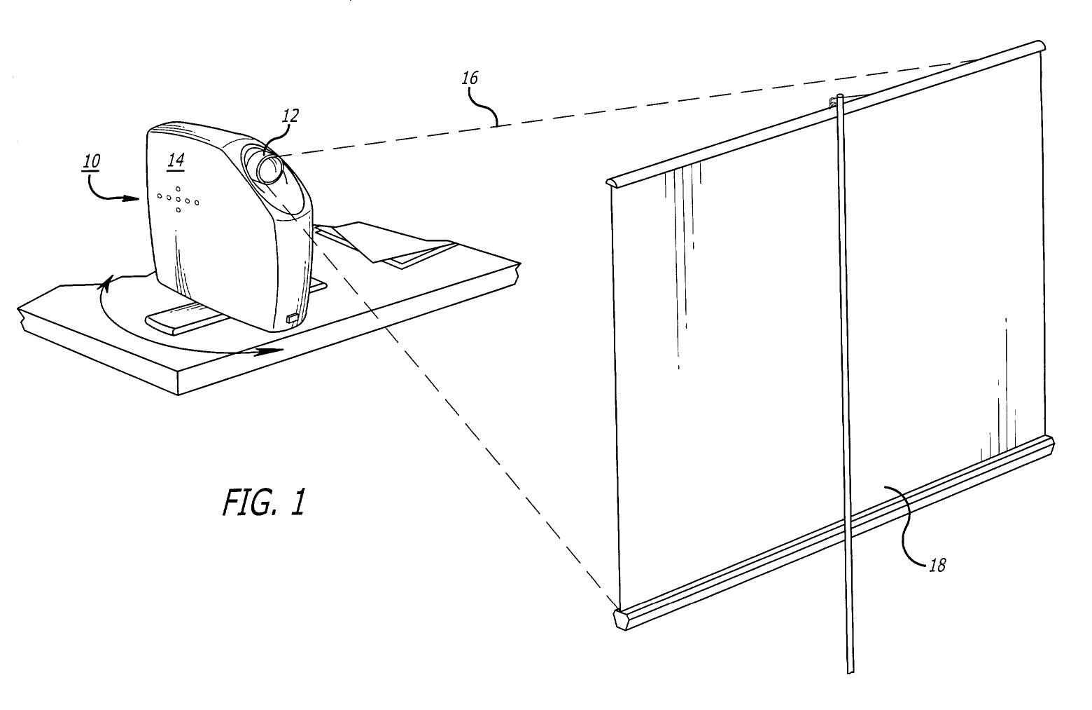

Referring to the drawings more particularly by reference numbers, FIG. 1 shows a projector computer 10. The projector 10 includes a light projector 12 that is attached to a housing 14. The light projector 12 can project an image 16 onto a surface such as a screen 18. The light projector 12 functions as a monitor for the computer 10. The projector computer 10 is packaged to be relatively small and lightweight so that the projector 10 is portable.

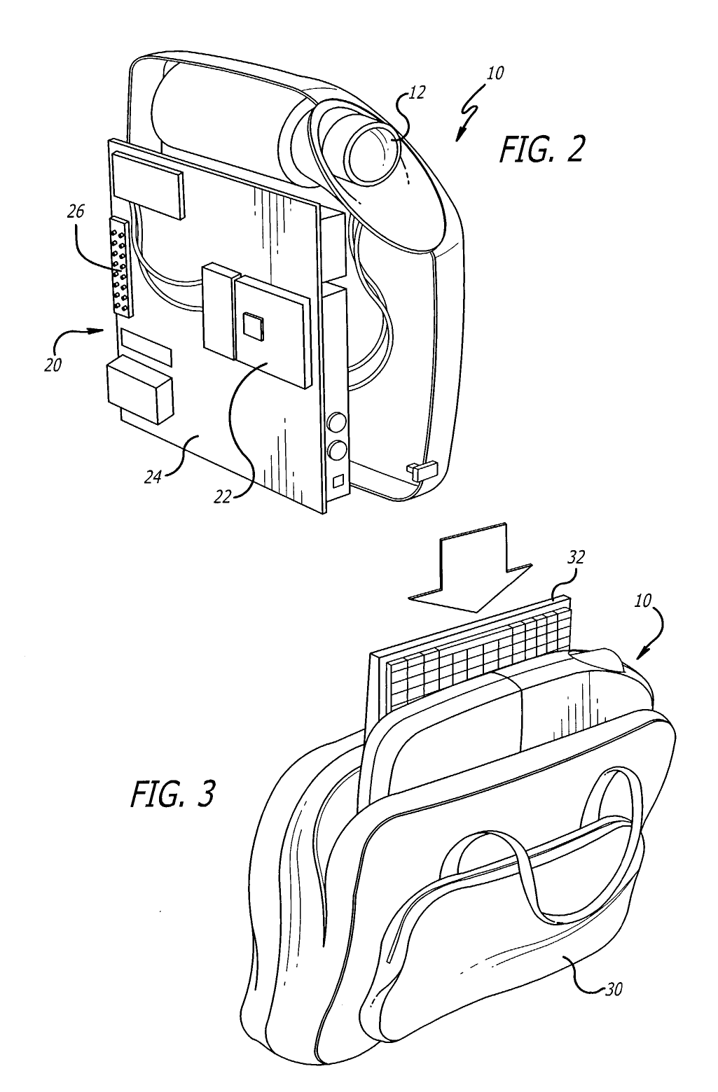

As shown in FIG. 2, the projector computer 10 may include a printed circuit board assembly 20. The assembly 20 includes a plurality of integrated circuit packages 22, each containing one or more integrated circuits, mounted to a printed circuit board 24. The assembly 20 may contain a plurality of electrical connectors 26 that couple the integrated circuits to other devices such as the light projector 12. The printed circuit board assembly 20 may be packaged as a separate transporter that can be plugged into the housing 14 and coupled to the light projector 12. By way of example, the transporter may be the same or similar to the computer transporter described in application Ser. No. 09/772,344, which is hereby incorporated by reference.

As shown in FIG. 3, the projector computer 10 may be carried in a bag 30. The bag 30 may also carry a wireless keyboard 32 that can be coupled to the computer 10.

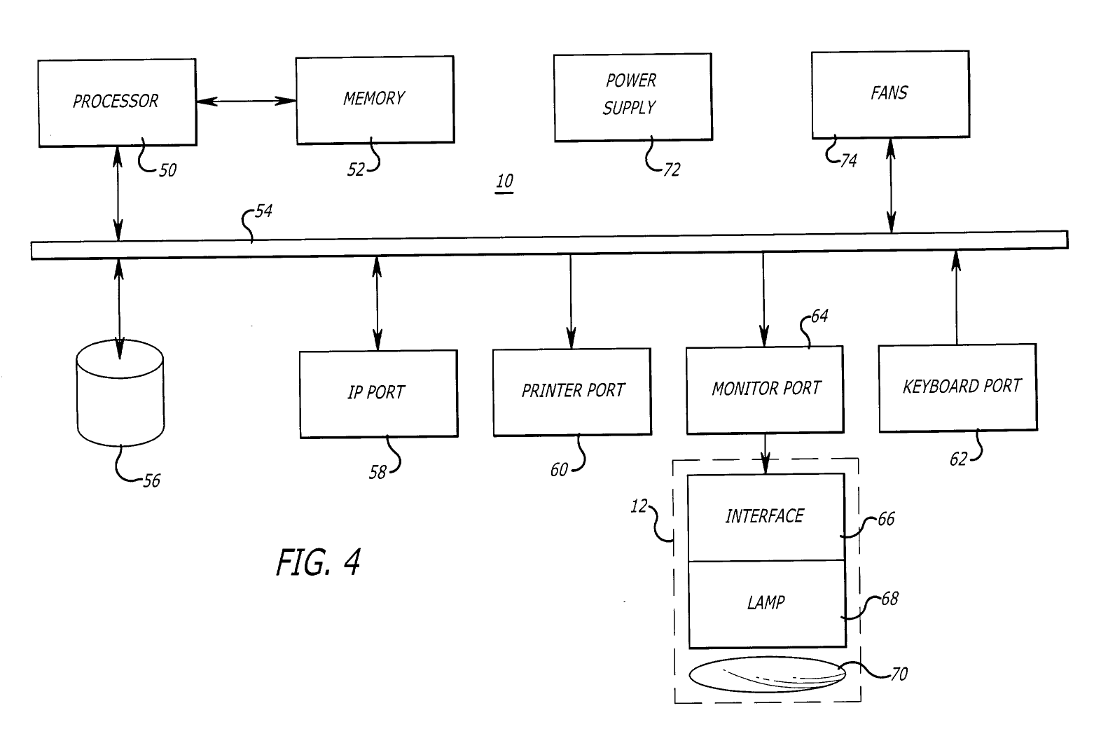

FIG. 4 shows an embodiment of the projector computer 10. The computer 10 includes a processor 50 that is coupled to memory 52. The processor 50 can perform software routines in conjunction with instructions and data stored in memory 52. The processor 50 can operate a computer operating system such as WINDOWS by Microsoft, Inc.

The processor 50 is also coupled to a bus 54. The computer 10 may also include a mass storage device 56 that is coupled to the bus 54. By way of example, the mass storage device 56 may be a hard disk drive. The bus 54 may be coupled to an IP port 58, a printer port 60 and a keyboard port 62. The IP port 58 may include individual ports for both telephone and network connection. Each port 58, 60 and 62 may include an electrical connector and/or a wireless receiver, a transmitter, and/or a transceiver. For example, the keyboard port 62 may include a wireless receiver that is coupled to the wireless keyboard shown in FIG. 3.

The computer 10 further includes a monitor port 64 that drives the light projector 12. The light projector 12 includes interface electrical circuits 66 that are coupled to a lamp 68. The lamp 68 emits light that is focused by a lens(es) 70. By way of example, the light projector 12 may utilize technology sold by Texas Instruments under the trademark DIGITAL LIGHT PROCESSING.

The projector computer 10 may include a power supply 72 that powers the electrical circuits and light projector 12. By way of example, the power supply 72 may include a 110 volt source with transformers to reduce the voltage to appropriate levels for use by the integrated circuits.

The processor 50 typically generates image data that is provided to the monitor port 64. The light projector 12 converts the image data into a light image that is projected onto a surface. The image data may be graphics or video. Although a processor is shown and described, it is to be understood that the computer 10 may have a graphics co-processor that provides image data to the monitor port 64 and projector 12.

The projector computer 10 may also include one or more fans 74 that can generate an air flow within the computer housing to maintain the electrical circuits and light projector 12 in a range of operating temperatures. The fans 74 may be operated in conjunction with a thermal management system run by the processor 50. The fans 74 and housing 14 are preferably designed to allow operation of the lamp 68 without creating a housing temperature that would be undesirable to human contact.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A projector computer, comprising:
a housing;
a processor that is attached to said housing and operates a computer operating system;
a memory that is attached to said housing and coupled to said processor; and,
a light projector that is attached to said housing and coupled to said processor.

2. The projector computer of claim 1, wherein said light projector includes a lamp and a lens.

3. The projector computer of claim 1, further comprising a fan coupled to said housing.

4. The projector computer of claim 1, further comprising a screen that can display an image projected by said light projector.

5. The projector computer of claim 1, further comprising a wireless receiver coupled to said housing and said processor.

6. The projector computer of claim 5, further comprising a wireless keyboard coupled to said wireless receiver.

7. A projector computer that can project an image onto a surface, comprising:
a housing;
processor means for operating a computer operating system and generating image data that corresponds to an image, said processor means being attached to said housing; and,
projector means for receiving said image data and projecting the image onto the surface, said projector means being attached to said housing.

8. The projector computer of claim 7, wherein said projector means includes a lamp and a lens.

9. The projector computer of claim 7, further comprising a fan coupled to said housing.

10. The projector computer of claim 7, further comprising a wireless receiver coupled to said housing and said processor.

11. The projector computer of claim 10, further comprising a wireless keyboard coupled to said wireless receiver.

12. A projector computer, comprising:
a housing;
a processor that is attached to said housing and operates a computer operating system;
a memory that is attached to said housing and coupled to said processor;
an IP port that is attached to said housing and coupled to said processor;
a hard disk drive that is attached to said housing and coupled to said processor; and,
a light projector that is attached to said housing and coupled to said processor.

13. The projector computer of claim 12, wherein said light projector includes a lamp and a lens.

14. The projector computer of claim 12, further comprising a fan coupled to said housing.

15. The projector computer of claim 12, further comprising a screen that can display an image projected by said light projector.

16. The projector computer of claim 12, further comprising a wireless receiver that is attached to said housing and coupled to said processor.

17. The projector computer of claim 16, further comprising a wireless keyboard coupled to said wireless receiver.
